(19) United States
(12) Patent Application Publication
(10) Pub. No.: US 2024/0405438 A1
(43) Pub. Date: Dec. 5, 2024

(54) ANTENNA ARRAY AND COMMUNICATION DEVICE

(71) Applicant: BEIJING XIAOMI MOBILE SOFTWARE CO., LTD., Beijing (CN)

(72) Inventors: Dong CHEN, Beijing (CN); Liangang CHI, Beijing (CN)

(21) Appl. No.: 18/700,688

(22) PCT Filed: Oct. 15, 2021
(86) PCT No.: PCT/CN2021/124106

§ 371 Date: Apr. 11, 2024

(51) Int. Cl. H01Q 15/00; H01Q 21/06

(52) U.S. Cl. CPC H01Q 15/0086; H01Q 21/065

(57) ABSTRACT

An array antenna includes an upper dielectric plate, a middle dielectric plate and a lower dielectric plate disposed from top to bottom, and the middle dielectric plate comprises a metasurface structure formed by a liquid crystal material. The metasurface structure may include a liquid crystal material layer, a digital radiation assembly printed on the liquid crystal material layer, and a direct current bias wire. The digital radiation assembly may include M×M digital radiation units arranged in an array, each of the digital radiation units comprises N×N indium tin oxide (ITO) radiation patches arranged in an array, and ITO radiation patches arranged in a same row are connected by the direct current bias wire.

### CROSS-REFERENCE TO RELATED APPLICATION

This application is a national phase application of International Application No. PCT/CN2021/124106, filed Oct. 15, 2021, the entire contents of which are incorporated herein by reference.

### TECHNICAL FIELD

The present disclosure relates to the field of communication technology, and particularly to an array antenna and a communication device.

### BACKGROUND

A metasurface antenna is an array of antennas having a sub-wavelength thickness. In the related art, a reconfigurable metasurface may be realized by adding an adjustable element and material such as a diode into a unit of a metasurface antenna and adjusting bias voltage. However, the diode is only suitable for use in a lower microwave frequency band, and only several states may be regulated by using the diode. Regarding a metasurface antenna operating at a high frequency band, such as a millimeter wave frequency band or higher, there is no ready-made device in the related art, and cost for producing a completed integrated circuit is high, and the loss is large.

### SUMMARY

According to a first aspect of embodiments of the present disclosure, there is provided an array antenna, which includes: an upper dielectric plate, a middle dielectric plate and a lower dielectric plate disposed from top to bottom, and the middle dielectric plate includes a metasurface structure formed by a liquid crystal material.

According to a second aspect of embodiments of the present disclosure, there is provided a communication device, which includes the array antenna as described in the first aspect.

### BRIEF DESCRIPTION OF THE DRAWINGS

In order to clearly illustrate embodiments of the present disclosure or technical solutions in the related art, a brief description of drawings to be used in embodiments or in the related art is given below.

FIG. 1 is a schematic side view of a unit structure of an array antenna;

FIG. 2 is a schematic structural diagram of a digital radiation assembly;

FIG. 3 is a schematic top view of a digital radiation unit;

FIG. 4 is a schematic side view of a unit structure of another array antenna;

FIG. 5 is a simulation curve illustrating a reflection amplitude and a reflection phase of a digital radiation assembly as a function of frequency;

FIG. 6 is a schematic diagram illustrating a simulation result of a three-dimensional far-field pattern obtained when a number coding sequence is “0000” at 29 GHz;

FIG. 7 is a schematic diagram illustrating a simulation result of a three-dimensional far-field pattern obtained when a number coding sequence is “0101” at 29 GHz; and

FIG. 8 is a block diagram illustrating a communication device for implementing an array antenna of embodiments of the present disclosure.

### DETAILED DESCRIPTION

To facilitate understanding, terms involved in the present disclosure are first described.

### 1. Metasurface

A metamaterial is an artificial structure formed by multiple sub-wavelength units arranged periodically, and by changing the structure and arrangement of the units of the metamaterial, many physical phenomena which do not exist in nature may be realized, such as inverse Doppler Effect, negative refraction, inverse Cherenkov radiation and the like. With a demand for highly integrated and low profile metamaterials, the unit structures may be arranged in a two-dimensional form on a plane to constitute the metasurface. Different from the metamaterial that uses spatial phase accumulation to control a phase of an electromagnetic wave, the metasurface adjusts and controls the electromagnetic wave by using abrupt change of the phase and amplitude obtained when an incident electromagnetic wave reaches the surface of a unit, which has advantages of low profile and easy integration.

### 2. Digital Metasurface

States of a unit of the metasurface is represented by a finite number of binary values. Taking a 1-bit digital metasurface as an example, an initial state is represented by “0”, and a state that has a phase difference of 180° relative to the initial state is represented by “1”. The discrete phase states are in one-to-one correspondence with pieces of digital information, and scattering and deflection of the electromagnetic wave may be adjusted and controlled by changing the encoding state. The more encoding bits the digital metasurface has, the more precise the regulation of the electromagnetic wave becomes.

### 3. Indium Tin Oxide (ITO)

ITO is a mixture including 90% of In2O3 and 10% of SnO2, and appears as a transparent brown film or a yellowish gray block. The ITO is mainly used for manufacturing a liquid crystal display, a flat panel display, a plasma display, a touch screen, an electronic paper, an organic light emitting diode, a solar cell, an antistatic coating, a transparent conductive coating for electromagnetic interference (EMI) shielding, various optical coatings and the like; and has characteristics of electrical conduction and optical transparency.

Embodiments of the present disclosure provide an array antenna, which may be applied to radio systems for such as communications, broadcasting, television, radar and navigation, and relate to the field of smart antenna technology. By using a liquid crystal material as an adjustable material, an operation frequency band of a metasurface antenna can reach a millimeter waveband or even a terahertz frequency band, which expands the operation frequency band of the metasurface antenna, and enables the metasurface to have a continuously adjustable property. Moreover, an indium tin oxide (ITO) material is used for replacing a metal structure of a traditional metasurface, and an optical transparent property brought by the ITO material expands application scenes of the metasurface.

According to a first aspect of embodiments of the present disclosure, there is provided an array antenna, which includes: an upper dielectric plate, a middle dielectric plate and a lower dielectric plate disposed from top to bottom, and the middle dielectric plate includes a metasurface structure formed by a liquid crystal material.

With the array antenna according to embodiments of the present disclosure, by using the liquid crystal material as the adjustable material, an operation frequency band of a metasurface antenna can reach a millimeter waveband or even a terahertz frequency band, which expands the operation frequency band of the metasurface antenna, and enables the metasurface to have a continuously adjustable property.

In an implementation, the metasurface structure includes: a liquid crystal material layer, a digital radiation assembly printed on the liquid crystal material layer, and a direct current bias wire; the digital radiation assembly includes M×M digital radiation units arranged in an array, each of the digital radiation units includes N×N indium tin oxide (ITO) radiation patches arranged in an array, and ITO radiation patches arranged in a same row are connected by the direct current bias wire.

In an implementation, a value of N is a minimum integer value that satisfies a condition of λ₀<2×N×p, where λ₀ represents a free space wavelength, and p represents a radiation period of the ITO radiation patch.

In an implementation, the value of N is negatively correlated with a size of a maximum beam pointing angle and a number of beam pointing angles scanned by the metasurface structure, respectively.

In an implementation, each of the ITO radiation patches has a circular shape.

In an implementation, within an operation frequency band of the array antenna, the digital radiation units are constructed to have either of two different states between which a reflection phase difference is 180°, depending on the liquid crystal material changing with a voltage.

In an implementation, the two different states of the digital radiation units correspond to different representing values.

In an implementation, the digital radiation units are controlled row by row.

In an implementation, the lower dielectric plate includes a grounding plate made of an ITO material and a glass dielectric plate from top to bottom.

In an implementation, the upper dielectric plate is a glass dielectric substrate.

According to a second aspect of embodiments of the present disclosure, there is provided a communication device, which includes the array antenna as described in the first aspect.

The array antenna provided in the present disclosure will be described in detail below with reference to the accompanying drawings.

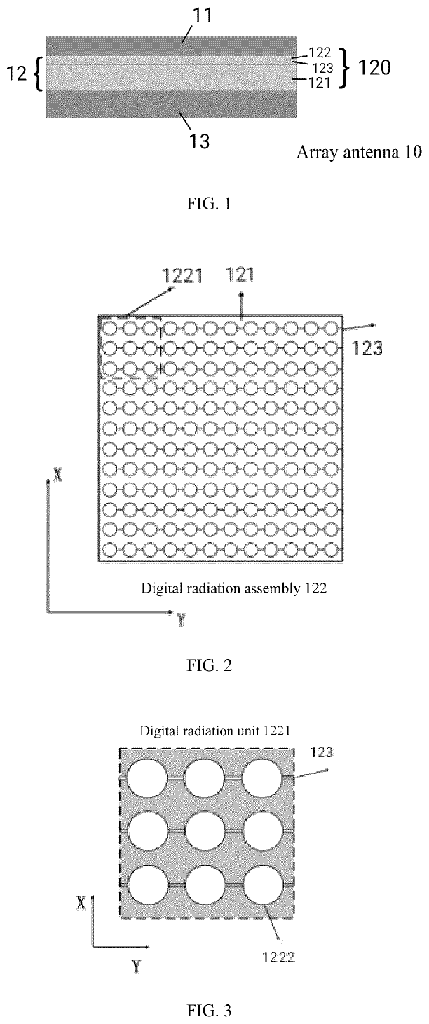

FIG. 1 is a schematic side view of a unit structure of an array antenna according to embodiments of the present disclosure. As shown in FIG. 1, the array antenna 10 includes an upper dielectric plate 11, a middle dielectric plate 12 and a lower dielectric plate 13 disposed from top to bottom, and the middle dielectric plate 12 includes a metasurface structure 120 formed by a liquid crystal material. By using the liquid crystal material as an adjustable material, an operation frequency band of the metasurface can reach a millimeter wave band or even a terahertz frequency band, which expands the operation frequency band of the array antenna.

Optionally, the metasurface structure 120 includes: a liquid crystal material layer 121, a digital radiation assembly 122 printed on the liquid crystal material layer, and a direct current bias wire 123.

In some implementations, the digital radiation assembly 122 includes M×M digital radiation units arranged in an array, where M represents both a number of rows and a number of columns of the digital radiation units. Each of the digital radiation units includes N×N indium tin oxide (ITO) radiation patches arranged in an array, where N represents both a number of columns and a number of rows of the ITO radiation patches in the digital radiation unit. The ITO material is used for replacing a metal structure of a traditional metasurface, and an optical transparent property brought by the ITO material expands application scenes of the metasurface.

FIG. 2 is a schematic structural diagram of a digital radiation assembly according to embodiments of the present disclosure. As shown in FIG. 2, the digital radiation assembly 122 includes 4×4 digital radiation units 1221 arranged in an array, and each of the digital radiation units 1221 include 3×3 ITO radiation patches 1222 arranged in an array. That is, in the digital radiation assembly shown in FIG. 2, M has a value of 4, and N has a value of 3. This is merely an example and is not intended to be a limitation of the present disclosure.

Optionally, a shape of the ITO radiation patch 1222 may be circular, square, elliptical or the like. In a case where the ITO radiation patch 1222 is circular, the radiation is more uniform in space.

In some implementations, a value of N, i.e., the number of columns and the number of rows of the ITO radiation patches 1222 in the digital radiation unit 1221, is a minimum integer value that satisfies a condition of λ₀<2×N×p, where do represents a free space wavelength, and p represents a radiation period of the ITO radiation patch 1222. This is because the value of N is negatively correlated with a size of a maximum beam pointing angle and a number of beam pointing angles scanned by the metasurface structure, respectively. That is, the smaller N is, the larger the maximum beam pointing angle is, and the more beam pointing angles may be scanned by the metasurface. In the present disclosure, the minimum integer value N satisfying the condition of λ₀<2×N×p is an optimal value of the N for the digital radiation unit of the 1-bit beam scanning metasurface.

Optionally, with a reflection phase difference of 180°, the digital radiation assembly is constructed to have either of two different states, and the two different states of the digital radiation assembly may correspond to different representing values. Specifically, different states of the digital radiation assembly may be represented by a finite number of binary values. For example, an initial state may be represented by “0”, and a state that has a phase difference of 180° relative to the initial state may be represented by “1”.

Within an operation frequency band of the array antenna, the digital radiation assembly is constructed to have either of two different states between which a reflection phase difference is 180°, depending on the liquid crystal material changing with a voltage. In some implementations, with the reflection phase difference of 180°, the digital radiation assembly is constructed to have either of two different states, and the two different states of the digital radiation assembly may correspond to different representing values. Specifically, the two different states of the digital radiation assembly may be represented by a finite number of binary values. For example, the initial state may be represented by “0”, and the state that has a phase difference of 180° relative to the initial state may be represented by “1”.

Taking the digital radiation assembly shown in FIG. 2 as an example, the digital radiation assembly includes 4×4 digital radiation units arranged in an array. Since the digital radiation assembly may be controlled by controlling the digital radiation units row by row, four digital radiation units in a row are in the same state. By controlling the state of the digital radiation units in each row, the digital radiation units may be arranged in different states, such as “0000”, “0101” or the like.

By changing a relative dielectric constant of the liquid crystal, the digital radiation assembly may be in either of two different states represented by “1” and “0”. Based on the above-mentioned principle, the digital radiation units in two states may be obtained, so that the arrangement of the units of the metasurface may be flexibly controlled, the digital radiation assembly is controlled by row, and different beam adjusting and controlling functions are realized.

FIG. 3 is a schematic top view of a digital radiation unit 1221 according to embodiments of the present disclosure. As shown in FIG. 3, the direct current bias wire 123 is located at a same layer as the ITO radiation patches 1222, the ITO radiation patches 1222 arranged in a same row are connected to each other by the direct current bias wire 123, and each row shares a same direct current bias wire 123 which extends to an outermost layer, so that a wiring situation of direct current feeds in an actual condition is simulated to a maximum extent, and an entire row of digital radiation units 1221 may be controlled by the direct current bias wire 123, thereby reducing the complexity of the feed network. That is, the relative dielectric constant of each row may be changed by the direct current bias wire 123 of the respective row, thereby enabling the digital radiation units 1221 to be in different states.

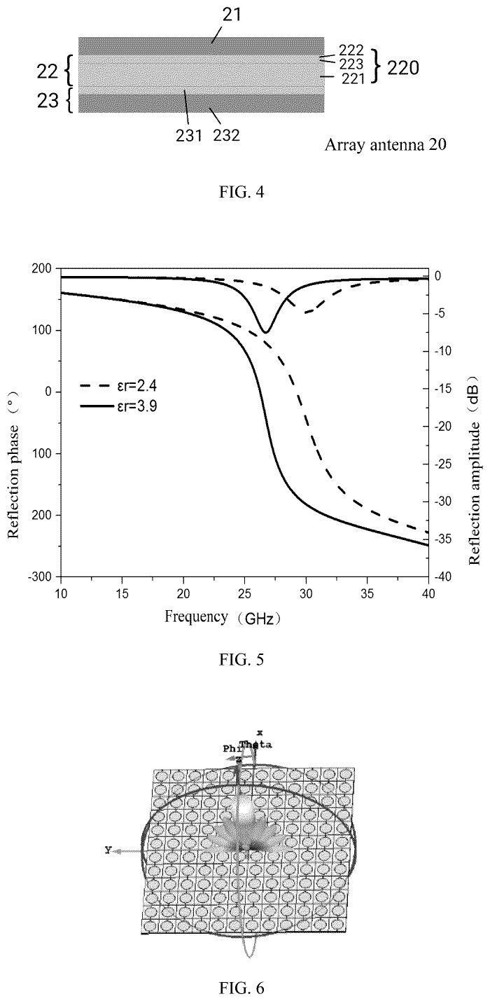

FIG. 4 is a schematic side view of a unit structure of another array antenna according to embodiments of the present disclosure. As shown in FIG. 4, the array antenna 20 includes an upper dielectric plate 21, a middle dielectric plate 22 and a lower dielectric plate 23 disposed from top to bottom.

Optionally, the upper dielectric plate 21 is a glass dielectric substrate, and the lower dielectric plate 23 includes a grounding plate 231 made of an ITO material and a glass dielectric plate 232 from top to bottom.

The middle dielectric plate 22 includes a metasurface structure 220 formed by a liquid crystal material, and the metasurface structure 220 includes: a liquid crystal material layer 221, a digital radiation assembly 222 printed on the liquid crystal material layer, and a direct current bias wire 223.

Optionally, the lower dielectric plate 23 includes the grounding plate 231 made of the ITO material and the glass dielectric plate 232 from top to bottom.

The digital radiation assembly 222 includes M×M digital radiation units arranged in an array, where M represents both a number of rows and a number of columns of the digital radiation units, and each of the digital radiation units includes N×N ITO radiation patches arranged in an array, where N represents both a number of columns and a number of rows of the ITO radiation patches in the digital radiation units.

Regarding structural implementations of the digital radiation assembly 222 in embodiments of the present disclosure, reference may be made to FIG. 2 in the above-mentioned embodiments of the present disclosure, which will not be described in detail here.

Optionally, each of the ITO radiation patches has a circular shape.

In some implementations, a value of N, i.e., the number of columns and the number of rows of the ITO radiation patches in the digital radiation unit, is a minimum integer value that satisfies a condition of λ₀<2×N×p, where do represents a free space wavelength, and p represents a radiation period of the ITO radiation patch 1222. This is because the value of N is negatively correlated with a size of a maximum beam pointing angle and a number of beam pointing angles scanned by the metasurface structure, respectively. That is, the smaller N is, the larger the maximum beam pointing angle is, and the more beam pointing angles may be scanned by the metasurface. In the present disclosure, the minimum integer value N satisfying the condition of 20<2×N×p is an optimal value of the N for the digital radiation unit of the 1-bit beam scanning metasurface.

Optionally, with a reflection phase difference of 180°, the digital radiation assembly is constructed to have either of two different states, and the two different states of the digital radiation assembly may correspond to different representing values. Specifically, different states of the digital radiation assembly may be represented by a finite number of binary values. For example, an initial state may be represented by “0”, and a state that has a phase difference of 180° relative to the initial state may be represented by “1”.

Within an operation frequency band of the array antenna, the digital radiation assembly is constructed to have either of two different states between which a reflection phase difference is 180°, depending on the liquid crystal material changing with a voltage. In some implementations, with the reflection phase difference of 180°, the digital radiation assembly is constructed to have either of two different states, and the two different states of the digital radiation assembly may correspond to different representing values. Specifically, the two different states of the digital radiation assembly may be represented by a finite number of binary values. For example, the initial state may be represented by “0”, and the state that has a phase difference of 180° relative to the initial state may be represented by “1”.

By changing a relative dielectric constant of the liquid crystal, the digital radiation assembly may be in either of two different states represented by “1” and “0”. Based on the above-mentioned principle, the digital radiation units in two states may be obtained, so that the arrangement of the units of the metasurface may be flexibly controlled, the digital radiation assembly is controlled by row, and different beam adjusting and controlling functions are realized.

In some implementations, the relative dielectric constant of each row may be changed by the direct current bias wire 123 of the respective row, thereby enabling the digital radiation units 1221 to be in different states. The entire row of digital radiation units may be controlled by the direct current bias wire 223, thereby reducing the complexity of the feed network. In some implementations, the change in the relative dielectric constant of an actual liquid crystal material as a function of voltage may be simulated by setting liquid crystal materials with different dielectric constants. Optionally, a value of the relative dielectric constant of the liquid crystal material layer may be modified in a simulation software to simulate the change with the voltage of both ends in the actual situation. The liquid crystal material with continuously changed dielectric constant values may be easily set by using the simulation software, without setting a large number of comparison groups in actual practices, more accurate numerical results may be obtained, and errors are avoided.

Taking the structure of the digital radiation assembly shown in FIG. 2 as an example, in a case where the relative dielectric constant of the liquid crystal is changed, simulation curves of a reflection amplitude and a reflection phase of the digital radiation assembly as a function of frequency are shown in FIG. 5. It may be seen that when the frequency is around 29 GHz, a difference between a reflection phase of the liquid crystal material when the relative dielectric constant εᵣ=2.4 and a reflection phase of the liquid crystal material when the relative dielectric constant εᵣ=3.9 is 180°.

With the reflection phase difference of 180°, the digital radiation assembly is constructed to have either of two different states, and the two different states of the digital radiation assembly may correspond to different representing values. Specifically, the two different states of the digital radiation assembly may be represented by a finite number of binary values. For example, the initial state may be represented by “0”, and the state that has a phase difference of 180° relative to the initial state may be represented by “1”. In this way, at the frequency of around 29 GHz, a unit corresponds to the state “0” in a case where the relative dielectric constant of the liquid crystal material is εᵣ=2.4, and a unit corresponds to the state “1” in a case where the relative dielectric constant of the liquid crystal material is εᵣ=3.9.

Since the digital radiation assembly includes 4×4 digital radiation units arranged in an array, and the digital radiation units may be controlled row by row, the four digital radiation units in a row may be in different states. By controlling the states of the digital radiation units in each row, the units may be arranged in different states, such as “0000”, “0101” or the like.

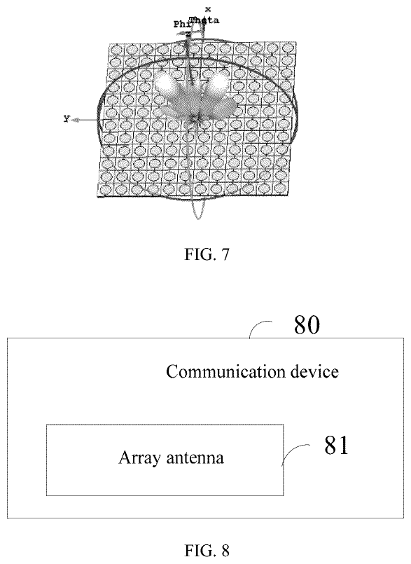

The following explains a process of controlling the digital radiation assembly to realize different beam adjusting and controlling functions with verification through the simulation software. When the dielectric constant of the liquid crystal is changed so that the units are arranged in a mode of “0000”, the three-dimensional far-field pattern has only one main beam, as shown in FIG. 6. When the dielectric constant of the liquid crystal is continuously changed so that the units are arranged in a mode of “0101”, the main beam in a state represented by an original code “0000” is split into two symmetrical beams, as shown in the three-dimensional far-field pattern of FIG. 7.

FIG. 8 is a schematic block diagram illustrating an example communication device 80 that may be used for implementing embodiments of the present disclosure. The communication device includes the array antenna described above, and may be a terminal device or a network device.

The terminal device may also be referred to as a terminal, a user equipment (UE), a mobile station (MS), a mobile terminal (MT), etc. The terminal device may be a device with a communication function, such as an automobile, a smart automobile, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. Embodiments of the present disclosure do not limit the specific technology and the specific device form used by the terminal device.

The network device may be an evolved NodeB (eNB), a transmission reception point (TRP), a next generation NodeB (gNB) in an NR system, a base station in other future mobile communication systems, or an access node in a wireless fidelity (WiFi) system, etc. Embodiments of the present disclosure do not limit the specific technology and the specific device form used by the terminal device. The network device according to embodiments of the present disclosure may be composed of a central unit (CU) and distributed units (DUs), and the CU may also be referred to as a control unit. Using the CU-DU structure, a protocol layer of the network device, such as a base station, may be split, so that a part of functions of the protocol layer is centrally controlled in the CU, some or all of the remaining functions of the protocol layer are distributed in the DUs, and the DUs are centrally controlled by the CU.

Those skilled in the art may appreciate that first, second, and other serial numbers involved in the present disclosure are merely for convenience of description and are not intended to limit the scope of embodiments of the present disclosure, nor do they represent a sequential order.

The term “at least one” used in the present disclosure may also be described as “one or more”, and the term “a plurality of” may be two, three, four, or more, and the present disclosure is not limited thereto. In embodiments of the present disclosure, for a certain kind of technical features, the technical features in this kind of technical features are distinguished by terms like “first”, “second”, “third”, “A”, “B”, “C” and “D”, etc., and these technical features described with the “first”, “second”, “third”, “A”, “B”, “C” and “D” have no order of priority or have no order of size.

The correspondence shown in each table in the present disclosure may be configured or predefined. The values of various information in each table are just examples, and may be configured as other values, which are not limited in the present disclosure. When configuring a correspondence between the information and various parameters, it is not necessary to configure all the correspondences shown in the tables. For example, the correspondences shown in some rows of a table in the present disclosure may not be configured. For another example, appropriate deformations or adjustments (such as splitting, merging, and so on) can be made on the basis of the above table. The names of parameters shown in the titles of the above tables may also adopt other understandable names of the communication device, and the values or representations of the parameters may also be other understandable values or representations of the communication device. When the above tables are implemented, other data structures may also be used, such as arrays, queues, containers, stacks, linear tables, pointers, linked lists, trees, graphs, structural body, classes, heaps, hash tables, or the like.

The above description only involves some specific embodiments of the present disclosure, but the scope of the present disclosure is not limited thereto. Any person skilled in the art may easily think of changes or substitutions within the technical scope of the present disclosure, which shall be covered by the protection scope of the present disclosure. Therefore, the protection scope of the present application shall be in line with the attached claims.

1. An array antenna, comprising:
an upper dielectric plate, a middle dielectric plate and a lower dielectric plate disposed from top to bottom, wherein the middle dielectric plate comprises a metasurface structure formed by a liquid crystal material.

2. The array antenna of claim 1, wherein the metasurface structure comprises: a liquid crystal material layer, a digital radiation assembly printed on the liquid crystal material layer, and a direct current bias wire;
wherein the digital radiation assembly comprises M×M digital radiation units arranged in an array, each of the digital radiation units comprises N×N indium tin oxide (ITO) radiation patches arranged in an array, and ITO radiation patches arranged in a same row are connected by the direct current bias wire.

3. The array antenna of claim 2, wherein a value of N is a minimum integer value that satisfies a condition of λ₀<2×N×p, wherein λ₀ represents a free space wavelength, and p represents a radiation period of the ITO radiation patch.

4. The array antenna of claim 3, wherein the value of N is negatively correlated with a size of a maximum beam pointing angle and a number of beam pointing angles scanned by the metasurface structure, respectively.

5. The array antenna of claim 2, wherein each of the ITO radiation patches has a circular shape.

6. The array antenna of claim 2, wherein within an operation frequency band of the array antenna, the digital radiation units are constructed to have either of two different states between which a reflection phase difference is 180°, depending on the liquid crystal material changing with a voltage.

7. The array antenna of claim 6, wherein the two different states of the digital radiation units correspond to different representing values.

8. The array antenna of claim 2, wherein the digital radiation units are controlled row by row.

9. The array antenna of claim 1, wherein the lower dielectric plate comprises a grounding plate made of an ITO material and a glass dielectric plate from top to bottom.

10. The array antenna of claim 1, wherein the upper dielectric plate is a glass dielectric substrate.

11. A communication device, comprising an array antenna comprising:
an upper dielectric plate, a middle dielectric plate and a lower dielectric plate disposed from top to bottom, wherein the middle dielectric plate comprises a metasurface structure formed by a liquid crystal material.

12. The communication device of claim 11, wherein the metasurface structure comprises: a liquid crystal material layer, a digital radiation assembly printed on the liquid crystal material layer, and a direct current bias wire;
wherein the digital radiation assembly comprises M×M digital radiation units arranged in an array, each of the digital radiation units comprises N×N indium tin oxide (ITO) radiation patches arranged in an array, and ITO radiation patches arranged in a same row are connected by the direct current bias wire.

13. The communication device of claim 12, wherein a value of N is a minimum integer value that satisfies a condition of λ₀<2×N×p, wherein λ₀ represents a free space wavelength, and p represents a radiation period of the ITO radiation patch.

14. The communication device of claim 13, wherein the value of N is negatively correlated with a size of a maximum beam pointing angle and a number of beam pointing angles scanned by the metasurface structure, respectively.

15. The communication device of claim 12, wherein each of the ITO radiation patches has a circular shape.

16. The communication device of claim 12, wherein within an operation frequency band of the array antenna, the digital radiation units are constructed to have either of two different states between which a reflection phase difference is 180°, depending on the liquid crystal material changing with a voltage.

17. The communication device of claim 16, wherein the two different states of the digital radiation units correspond to different representing values.

18. The communication device of claim 12, wherein the digital radiation units are controlled row by row.

19. The communication device of claim 11, wherein the lower dielectric plate comprises a grounding plate made of an ITO material and a glass dielectric plate from top to bottom.

20. The communication device of claim 11, wherein the upper dielectric plate is a glass dielectric substrate.
